(19) United States
(12) Patent Application Publication
(10) Pub. No.: US 2006/0069909 A1
(43) Pub. Date: Mar. 30, 2006

(54) Kernel registry write operations

(76) Inventors: Steven T. Roth, Sunnyvale, CA (US); Harshavardhan R. Kuntur, Sunnyvale, CA (US); Aswin Chandramouleeswaran, Santa Clara, CA (US); Lisa M. Nishiyama, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/947,945

(22) Filed: Sep. 23, 2004

(51) Int. Cl. G06F 9/00

(52) U.S. Cl. 713/100

(57) ABSTRACT

Systems, methods, and devices are provided for kernel registry write operations. One embodiment includes a computer readable medium having a program to cause a device to perform a method. The method includes forcing a write operation of kernel configuration information in a kernel registry service memory to a disk. The method also includes disabling subsequent kernel registry service memory writes to the disk while performing kernel configuration operations on the disk.

### BACKGROUND

In a computing device, such as a server, router, desktop computer, laptop, etc., and other computing devices having processor logic and memory, the computing device includes an operating system and a number of application programs that execute on the computing device. The operating system and the application programs are typically separated and provided in different software layers. For example, an operating system layer includes a “kernel” which is a master control program that runs the computing device.

The kernel provides functions such as task, device, and data management, among others. An application layer includes application programs that perform particular tasks. These programs can typically be added by a user or administrator as options to a computer device. Application programs are executable instructions, which are located above the operating system layer and accessible by a user.

The application layer and other user accessible layers are often referred to as being in “user space”, while the operating system layer can be referred to as “kernel space”. As used herein, “user space” implies a layer of code which is more easily accessible to a user, e.g., administrator, than the layer of code which is in the operating system layer or “kernel space”.

In an operating system parlance, the kernel is a set of modules forming the core of the operating system. The kernel is loaded into a main memory first during the startup of the computing device and remains in main memory, providing services such as memory management, process and task management, and disk management.

The kernel also handles such issues as startup and initialization of the computing device. Logically, a kernel configuration is a collection of the administrator choices and settings needed to determine the behavior and capabilities of the kernel. This collection includes a set of kernel modules (each with a desired state), a set of kernel tunable parameter value assignments, a primary swap device, a set of dump device specifications, a set of bindings of devices to other device drivers, a name and optional description of the kernel configuration, etc.

The kernel registry service (KRS) is a registry database that keeps information in memory and periodically will write kernel configuration information that is in memory to a file on a disk. This write operation typically occurs through a KRS daemon. However, when a user is changing the kernel configuration, since the KRS daemon writes to disk on a periodic cycle, the kernel configuration information that is written to the disk can be in various stages of change based upon the changes made by the user.

In such instances, the user may make a mistake in changing the kernel configuration such that the changed kernel configuration does not work correctly. The user would like to be able to return to a kernel configuration saved prior to when the changes were implemented. However, since the KRS daemon writes kernel configuration information to disk periodically, it may be that the version of the information on disk has some or all of the changes implemented therein. Accordingly, in these instances, the administrator has no way to return to a working version.

Additionally, the operations to write a kernel configuration to disk have been handled in an asynchronous manner such that when the write process is initiated, the kernel does not wait to see if the write has been completed or whether it has been successful. In this way, issues can arise with writes not being completed or multiple writes taking place at the same time which can lead to incorrect versions of kernel configuration information existing on the disk.

For example, to call the current kernel configuration, the kernel has to access the subdirectory in which the current kernel configuration information resides, and when the next boot kernel configuration is to be used, the kernel has to call the subdirectory in which the next boot kernel configuration information resides. In this way, several calls may have to be implemented in order to use a different kernel configuration.

### BRIEF DESCRIPTION OF THE DRAWINGS

FIG. 1 is a block diagram of a computer system suitable to implement embodiments of the invention.

FIG. 2A illustrates a kernel configuration having a number of modules.

FIG. 2B is a block diagram of an embodiment of a kernel build system suitable to implement embodiments of the invention.

FIG. 3 is a block diagram of an embodiment of a kernel configuration system.

FIG. 4 is a flow chart illustrating an embodiment for enabling and disabling a kernel registry write operation in association with a kernel configuration change.

### DETAILED DESCRIPTION

Program embodiments are provided which execute instructions to force a write operation of kernel configuration information in a kernel registry memory to a disk. The program instructions can execute to disable new kernel registry memory writes to the disk while performing kernel configuration operations on the disk.

The kernel registry service can be directed to write the kernel configuration information in the kernel registry service memory to the disk one time and then disable subsequent kernel registry service memory writes. This can be accomplished, for example, through the setting of a flag value in the kernel registry service. The flag value can be added to the kernel registry service or an existing flag can be changed to indicate write operations are to be disabled.

Subsequent kernel registry service memory writes to the disk can be enabled after the kernel configuration operations have been performed on the disk. This can also be accomplished by way of setting a flag value in the kernel registry service.

Program embodiments are also provided which execute instructions for editing a kernel configuration. The program instructions can also execute for holding the edited kernel configuration as a pending kernel configuration in memory with a current kernel configuration. The pending kernel configuration can be held in a particular subdirectory that also includes the current kernel configuration. The same file name can be used for both current and pending kernel configurations.

In order to differentiate the pending kernel configuration from the current kernel configuration, a flag can be set in the kernel registry services. Flags can also be associated with particular parameters of the kernel configuration information and can be associated with kernel registry service calls to indicate that the kernel registry service call is to be applied to either the pending or current kernel configuration.

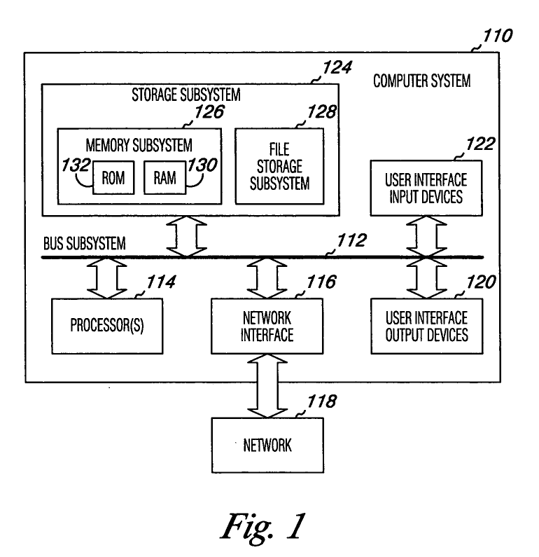

FIG. 1 is a block diagram of a computer system 110 suitable to implement embodiments of the invention. Computer system 110 includes at least one processor 114 which communicates with a number of other computing components via bus subsystem 112. These other computing components may include a storage subsystem 124 having a memory subsystem 126 and a file storage subsystem 128, user interface input devices 122, user interface output devices 120, and a network interface subsystem 116, to name a few. The input and output devices allow user interaction with the computer system 110.

The network interface subsystem 116 provides an interface to outside networks, including an interface to network 118 (e.g., a local area network (LAN), wide area network (WAN), Internet, and/or wireless network, among others), and is coupled via network 118 to corresponding interface devices in other computing systems.

Network 118 may itself be comprised of many interconnected computing systems and communication links, as the same are known and understood by one of ordinary skill in the art. Communication links as used herein may be hardwire links, optical links, satellite or other wireless communications links, wave propagation links, or any other mechanisms for communication of information.

User interface input devices 122 may include a keyboard, pointing devices such as a mouse, trackball, touchpad, or graphics tablet, a scanner, a touch screen incorporated into a display, audio input devices such as voice recognition systems, microphones, and other types of input devices. In general, use of the term “input device” is intended to include all possible types of devices and ways to input information into computing system 110 or onto computing network 118.

User interface output devices 120 may include a display subsystem, a printer, a fax machine, or non-visual displays such as audio output devices. The display subsystem may be a cathode ray tube (CRT), a flat-panel device such as a liquid crystal display (LCD) and/or plasma display, or a projection device (e.g., a digital light processing (DLP) device among others).

The display subsystem may also provide non-visual display such as via audio output devices. In general, use of the term “output device” is intended to include all possible types of devices and ways to output information from computer system 110 to a user or to another machine or computer system 110.

Storage subsystem 124 can include the operating system “kernel” layer and an application layer to enable the device to perform various functions, tasks, or roles. Memory subsystem 126 typically includes a number of memory locations and types including a main random access memory (RAM) 130 for storage of program instructions and data during program execution and a read only memory (ROM) 132 in which fixed instructions are stored. File storage subsystem 128 can provide persistent (non-volatile) storage for additional program and data files, and may include a hard disk drive, a floppy disk drive along with associated removable media, a compact digital read only memory (CD-ROM) drive, an optical drive, or removable media cartridges.

As used herein, a computer readable medium is intended to include the types of memory described above. Program embodiments as will be described further herein can be included with a computer readable medium and may also be provided using a carrier wave over a communications network such as the Internet, among others.

Bus subsystem 112 provides a mechanism for letting the various components and subsystems of computing system 110 communicate with each other as intended. Although bus subsystem 112 is shown schematically as a single bus, alternate embodiments of the bus subsystem 112 may utilize multiple busses.

Program embodiments according to the present invention can be stored in the memory subsystem 126, the file storage subsystem 128, and/or elsewhere in a distributed computing environment. Due to the ever-changing nature of computing devices and networks, the description of computer system 110 depicted in FIG. 1 is intended only as one example of a computing environment suitable for implementing embodiments of the present invention. Many other configurations of computer system 110 are possible having more or less components than the computing system depicted in FIG. 1.

Computer systems can include multiple computing devices such as servers, desktop PCs, laptops, and workstations, and can include peripheral devices, e.g., printers, facsimile devices, and scanners. The computing devices can be networked together across a local area network (LAN) and/or wide area network (WAN).

A LAN and/or WAN uses clients and servers that have network-enabled operating systems such as Windows, Mac, Linux, and Unix. An example of a client includes a user's workstation. Clients and servers can be connected in a client/server relationship in which the servers hold programs and data that are shared by the clients in the computing network.

As mentioned above, the kernel layer of a computing system manages the set of processes that are running on the system by ensuring that each process is provided with processor and memory resources at the appropriate time. A process refers to an executing program instruction, or application. The kernel provides a set of services that allow processes to interact with the kernel.

The kernel's set of services is expressed in a set of kernel modules. A module is a self contained set of instructions designed to handle particular tasks within a larger program. Kernel modules can be compiled and subsequently linked together to form a kernel. One example of a kernel module is a module which provides the KRS functionality.

Other types of modules can be compiled and subsequently linked together to form other types of programs. As used herein an operating system of a computing system can include a Unix, Linux, AIX, Windows, and/or Mac operating system, etc.

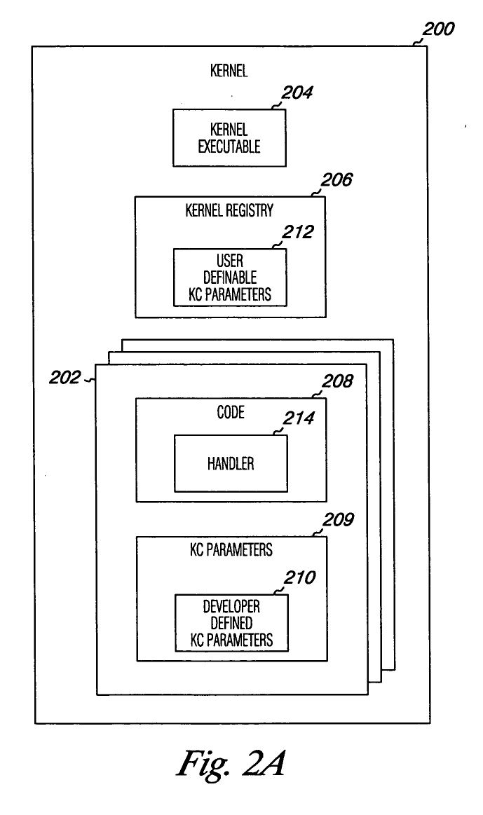

FIG. 2A illustrates a kernel configuration 200 having a number of modules 202. As one of ordinary skill in the art will appreciate, once a set of modules are created in a development environment for a kernel configuration 200, they can be shipped from a supplier to a user.

The modules can be shipped as a fully functioning kernel or as a number of modules to be assembled into a kernel. In some cases, a functioning kernel can be shipped with a number of modules that can be added or substituted for other modules making up the kernel that has been provided to the user.

Developer provided, kernel configuration (KC) parameters 209 can be made available to a user. Some kernel configuration parameters 209 (also referred to herein as logical settings) are set by the kernel developer (illustrated as 210), and cannot easily be changed subsequent to installation of the operating system kernel. For example, in various embodiments, some tunables are implemented when a computing device or system is rebooted. Others (illustrated as 212) may be changed by a user to provide a different logical setting. The change in logical setting can be useful, for example, in changing the kernel configuration based on user feedback received in response to a user interface feedback session. Some of these tunables can also be implemented at reboot.

As mentioned above, logically, a kernel configuration is a collection of the user choices and settings that are used to determine the behavior and capabilities of the kernel. This collection can include a set of kernel modules (each with a desired state), a set of kernel tunable parameter value assignments, a primary swap device, a set of dump device specifications, a set of bindings of devices to other device drivers, a name and optional description of the kernel configuration, etc.

Physically, a kernel configuration 200 is a directory that contains the files used to realize a desired behavior for the operating system. The directory includes: a kernel executable 204, a set of kernel module files 202, and a kernel registry database 206 (containing the logical settings described above).

As illustrated in FIG. 2A each kernel module 202 includes kernel code 208 and kernel configuration parameters, or logical settings, 209 (some developer defined 210 and some user definable 212 as illustrated in the kernel registry database 206). The kernel code 208 includes a kernel configuration handler function 214 which controls the kernel configuration parameters 209.

Kernel tunables are one example of kernel configuration parameters 209 which control some behavior of the operating system kernel. The tunable parameters are integer values used to define how the kernel is to behave. For example, tunable values can include a setting for the number of processes for each user on a system, a setting for a total number of processes on the system, security features, etc.

The tunable values are initialized by a tunable initialization function, which is part of the kernel code. Kernel tunable parameters are usually managed manually. Some tunable value changes, e.g. by a system administrator, can be implemented immediately to a running system, others cannot, and some can only be implemented through rebuilding the kernel. For example, it is not possible to immediately reduce the value of some resources below a current usage. When a kernel configuration parameter change, e.g., tunable value change, cannot be implemented immediately, the kernel may hold the value change in the kernel registry 206 and apply it at a later time, e.g., a next boot.

In one example Unix environment, the operating system kernel is a collection of around 350 kernel modules and has as many as 200 kernel tunables. This example environment is discussed herein for ease of illustration. However, the reader will appreciate that embodiments are not limited to a Unix operating system environment. In this Unix example, the kernel configuration parameters are managed by three commands known as kconfig, kcmodule, and kctune.

The kconfig command is used to manage whole kernel configurations. It allows operations to be performed on the configurations such as having the configuration information saved, loaded, copied, renamed, deleted, exported, imported, etc. It can also list existing saved configurations and give details about them.

The kcmodule command is used to manage kernel modules. Kernel modules can be device drivers, kernel subsystems, or other bodies of kernel code. Each module can have various module states including unused, static (compiled into the kernel and unable to be changed without rebuilding and rebooting), and/or dynamic (which can include both “loaded”, i.e., the module is dynamically loaded into the kernel, and “auto”, i.e., the module will be dynamically loaded into the kernel when it is first used, but has not been yet). That is, each module can be unused, statically bound, e.g., bound into the main kernel executable, or dynamically loaded. These states may be identified as the states describing how the module will be used as of the next system boot and/or how the module is currently being used in the running kernel configuration. Kcmodule will display or change the state of any module in the currently running kernel configuration or a saved configuration.

Kctune is used to manage kernel tunable parameters. As mentioned above, tunable values are used for controlling allocation of system resources and tuning aspects of kernel performance. Kctune will display or change the value of any tunable parameter in the currently running configuration or a saved configuration.

As the reader will appreciate, kernel configuration includes configuring and managing fairly distinct kernel domain entities. Some of these domain entities include those mentioned above, e.g., kernel tunables and kernel modules.

FIG. 2B is a block diagram of an embodiment of a build system suitable to implement embodiments of the invention. As shown in the example illustration of FIG. 2B a system user, e.g., a system administrator, may be provided with access to a number of modules, shown generally as 202, and be able to load and unload modules (described below) from a kernel configuration 200 as part of installing, updating (upgrading), and/or managing an operating system kernel on a system based on user feedback received in response to a customer user interface feedback session.

As illustrated in FIG. 2B, the modules in a kernel (e.g., modules 202 in kernel configuration 200 of FIG. 2A) can be provided to a linker utility 224 that is used to join modules together to make a program, e.g., kernel configuration, for the particular user's system. This part of the process may be performed in either the development environment or the runtime environment, i.e., on a user's system.

As illustrated in the embodiment of FIG. 2B, a system user may be provided with a kernel configuration tool, shown as kconfig 228, which executes program instructions to implement the embodiments described in further detail below. The kconfig 228 tool can read the modules, e.g., 202 in FIG. 2A, in the developer provided kernel 200 to find out what modules are available and set and select from among multiple saved kernel configurations. As illustrated in FIG. 2B the linker 224 can receive instructions from the kconfig 228 tool. The result of this process is a complete program, e.g., kernel file 232, that the user can install on and use to run their system.

The kconfig tool 228 can allow a system administrator to specify various kernel configuration parameters, e.g., module states, tunable values, etc. The kconfig tool 228 can also be used to save and select from among multiple kernel configurations. An example of saving multiple kernel configurations can be found in co-pending application entitled, “Multiple Saved Kernel Configurations”, application Ser. No. 10/440,100, filed on May 19, 2003, assigned to the instant assignee, and incorporated herein by reference. In this co-pending application, once satisfied with a kernel configuration, an administrator may desire to save a copy of the kernel configuration for a variety of reasons.

For example, the administrator may want to have working backup configurations, protect the system against inadvertent configuration changes, be able to switch between different kernel configurations in different system usage environments, and/or provide copies of kernel configurations on multiple platforms. Such administrator chosen parameter values and kernel configurations can be contained in user system files 226. Thus, the “system file” 226 is a way of describing a kernel configuration and each saved kernel configuration can specify different kernel configuration parameters, e.g., module states, tunable values, etc., that the user wants to use.

In the prior application, the KRS can be used to store multiple copies of the kernel configuration on disk. This can be done by storing the current kernel configuration information in one subdirectory of a directory tree and the other kernel configuration information in one or more other separate subdirectories within the directory tree.

In various embodiments of the present invention, system users, e.g., system administrators, may make changes to a running kernel configuration that are not to take effect until a next system boot. These changes can be referred to as pending changes, pending data, or generally as a pending kernel configuration.

In such embodiments, the changes to be affected are held in abeyance until the next boot, at which time they are implemented. For example, it may be desired that a tunable be changed for the next boot configuration, but maintained in its current state until the next boot. In such a case, the tunable change can be designated to take affect at the next boot. The change will be held until the next boot, at which time the tunable will be changed accordingly. Program instructions can be provided to execute the function of holding the change until next boot and to automatically implement the changes to be made when the next boot occurs.

The function of linking modules can be accomplished at the time that the entire software program is initially compiled and can be performed at a later time either by recompiling the program “offline” or, in some instances, while the program is executing “online” in a runtime environment. As the reader will appreciate, most operating system users are interested in high availability. That is, business networks can experience significant losses when a network operating system is down “offline” even for a short period. In many user environments, it may be difficult to justify taking a system “offline” to rebuild and hence rebooting the system may not be a viable alternative in order to effectuate kernel configuration changes.

The process of linking modules at runtime is also referred to as loading a module. The reverse process of unlinking a module at runtime is referred to as unloading a module. Runtime loading and unloading accommodates the user's desire for high availability. In many cases, when modules are loaded or unloaded the computing device or system has to be configured in a particular way in order for the module to load or unload correctly. For example, a module may have to seek access to another module to be properly loaded or unloaded. A module may also need access to other data to be used once the module is loaded.

Additionally, a module may have to use program instructions to perform certain tasks in connection with the loading or unloading, e.g., may seek access to certain kernel parameters such as the aforementioned tunables, device bindings, swap and/or dump devices, etc. For example, a given tunable A may be defined as Tunable A=Tunable B+Tunable C. Thus, if either Tunable B or Tunable C changes then Tunable A has to change as well. If these operations are not accomplished correctly, such as before and/or after a module is loaded/unloaded, the loading and/or unloading of the module may not be achieved or the kernel may get into an error state from which it is unable to recover.

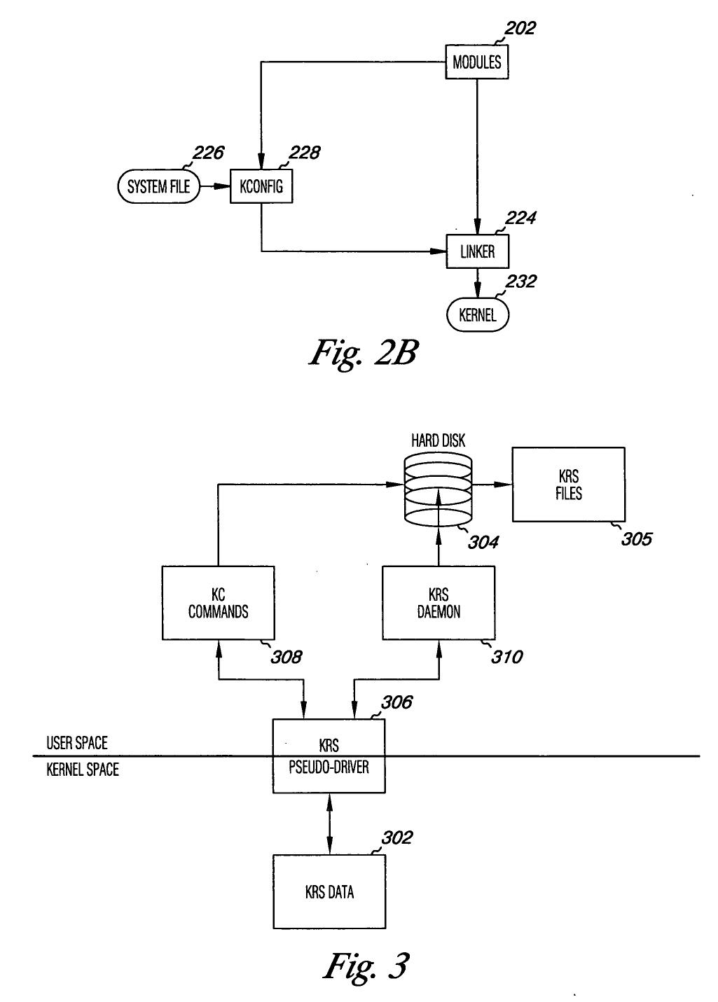

FIG. 3 is a block diagram of an embodiment of a kernel configuration system. FIG. 3 illustrates one example Unix environment for handling kernel configuration information. The embodiment of FIG. 3 illustrates how kernel registry data (such as data within kernel registry database 206 of FIG. 2) is managed and how kernel configuration tools work with kernel registry data.

The embodiment of FIG. 3 also illustrates a delineation between kernel space and user space. In the embodiment of FIG. 3, the kernel registry data 302, in the Unix environment, is expressed as kernel registry service (KRS) data and is located in kernel space. The KRS data is read from a KRS file 305, or kernel registry file, which is located on a disk 304, e.g., hard disk, in user space.

According to various embodiments, once KRS data 302 is populated in the kernel space, a user space program can access the data using a kernel registry pseudo driver, e.g., KRS pseudo driver 306. The KRS pseudo-driver acts as an interface for accessing the KRS data 302 maintained in memory. The KRS data is also periodically saved to a hard disk, such as disk 304.

Kernel configuration commands 308, such as those described above, handle KRS information both from the KRS pseudo-driver 306 (which provides information from the kernel memory copy of KRS) and from the KRS files 305.

As illustrated in the embodiment of FIG. 3, a KRS daemon 310 is provided. As the reader will appreciate, a daemon is a program that executes in the background and is ready to perform an operation when required. Functioning like an extension to the operating system, a daemon is usually an unattended process that is initiated at startup. In the illustrative example, the KRS daemon 310 talks to the KRS pseudo driver and synchronizes the KRS data 302 in kernel space memory with the data on the disk 304 in the KRS file 305.

In various embodiments, an edited kernel configuration can be saved as a pending kernel configuration in memory with the current kernel configuration. That is, a kernel configuration can be held for use when the next boot occurs. For example, the pending kernel configuration can be held in the kernel memory copy of the kernel registry service. Pending data is data to be held in abeyance until the next system reboot. In some embodiments, the pending kernel parameters can be held in RAM while the current kernel configuration is running and can be saved to disk for use at the next boot.

The pending and current kernel configurations can be stored at the same directory location, e.g., within the same subdirectory of a larger directory structure, also referred to as a node. In some embodiments, the pending and current kernel configurations can be given the same filename. In such embodiments, instead of using the filename or location within the directory to differentiate the current and pending kernel configurations, a flag can be added to one or more of the configurations to differentiate them from each other. In this way, the configurations can all have the same name, can be stored on the same physical device, and can be in the same directory location. Therefore, the various calls directed to utilize a kernel configuration do not have to be changed because they use the filename in their call instructions.

Flags are identifiers of one or more bits that can be included in the program code of a program application. For example, a flag can be an octet bit structure within the machine language of a kernel configuration file. When the file is read, the flag can be identified and the meaning discerned. The meanings of various flags and instructions on how to proceed once a flag is identified can be provided in a data structure, such as a look-up list, among others.

Program instructions can execute to interpret the meaning of the various flags. For example, program instructions can provide that when a flag representing a pending kernel configuration is identified, the associated kernel configuration is to be held for use at the next boot. Program instructions can also be provided to automatically implement the pending kernel configuration at the next boot.

Additionally, particular kernel parameters can also use flags to indicate in which kernel configuration they are to be used. In this way, the kernel registry service can differentiate between kernel parameters and implement them in the appropriate kernel configuration. For example, flags can be used to differentiate parameters that are to be associated with pending (e.g., for next boot or other subsequent boots) and non-pending (e.g., current) kernel configurations.

In various embodiments, the KRS daemon 310 wakes up periodically, e.g. every 5 minutes, to write data to disk 304. As one of ordinary skill in the art will appreciate, this action is referred to as “flushing” data to disk. According to various embodiments, the “flush” operation may also be forced as suited to various environments.

In various embodiments, the operation of writing kernel information to disk can be disabled. This can be beneficial in a variety of circumstances. for example, when the kernel registry is being edited, copied, or moved, it may be useful to have a copy of the kernel before the kernel operation was performed. In such instances, the daemon may initiate a write operation that will overwrite the pre-kernel operation version of the kernel configuration information, if the write operation is not disabled.

The write operation can be disabled through the use of a flag that indicates to the daemon that it is not supposed to perform the write operation at this time. A flag can be used to indicate that the daemon is to perform one write operation and then discontinue subsequent write operations until further notice. Additionally, program instructions can be provided to force a write operation either immediately or when the flag is encountered by the daemon.

Program instructions can also be provided to notify other program instructions, which are using the kernel registry service, when the write operation (e.g., forced write operation) has been successfully completed. This allows the program instructions that are using the kernel registry service to know when it should proceed with an update of kernel configuration information.

The notice to enable write operations can be provided by adding or setting a flag also. In this way, when the daemon sees the added or changed flag that means to enable write operations, the daemon can begin to initiate write operations again. The change between an enabled and a disabled state can be accomplished before, during, or after a kernel operation has been initiated.

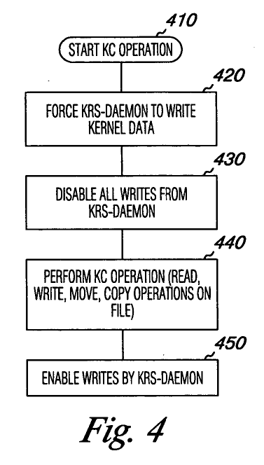

FIG. 4 is a flow chart illustrating an embodiment for enabling and disabling a kernel registry write operation in association with a kernel configuration change. As illustrated in the example embodiment of FIG. 4, a typical kernel configuration (KC) may involve doing several file operations using the KRS to save files, shown in FIG. 3 as 305. As one of ordinary skill in the art will appreciate, kernel configuration operations include: read, write, move, and copy. Additionally, the state of write operations can be changed at various times. For example, the write operations can be disabled or enabled when the system is updated, when the kernel is installed, when a kernel configuration is changed, or when a change is made at pre-boot or post-boot, for example.

In this illustrative embodiment shown in FIG. 4, once a KC operation starts, as shown at block 410, the KRS daemon (306 in FIG. 3) is forced to perform a write operation to write the kernel registry information (KRS data 302 in FIG. 3) to disk (305 and 304 in FIG. 3), as shown at block 420. As shown in the embodiment of FIG. 4, program instructions execute such that KC commands (308 in FIG. 3) set a value to be seen by the daemon (310 in FIG. 3) in order to ensure that all writes to the KRS file (302 in FIG. 3) are disabled, as shown at block 430.

As shown at block 440, the program instructions then execute to perform all KC changes to disk (304 in FIG. 3). As one of ordinary skill in the art will appreciate, since the KRS daemon (310 in FIG. 3) is disabled, the program instructions can execute in association with the KC tools (e.g., 228 in FIG. 2B) to perform the operations of the kernel configuration change (e.g., read, write, move, and copy, etc., as described above). As shown in the example embodiment of FIG. 4, once the KC tools (e.g., 228 in FIG. 2B) have completed their operations in block 440, program instructions execute to re-enable write operations from the KRS daemon (310 in FIG. 3), as shown at block 450.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computer readable medium having a program to cause a device to perform a method, comprising:
forcing a write operation of kernel configuration information in a kernel registry service memory to a disk; and
disabling subsequent kernel registry service memory writes to the disk while performing kernel configuration operations on the disk.

2. The medium of claim 1, wherein the method further includes directing a kernel registry service to write the kernel configuration information in the kernel registry service memory to the disk one time and then disable subsequent kernel registry service memory writes.

3. The medium of claim 2, wherein directing the kernel registry service includes setting a flag value in the kernel registry service.

4. The medium of claim 1, wherein the method further includes enabling subsequent kernel registry service memory writes to the disk after performing kernel configuration operations on the disk.

5. The medium of claim 4, wherein enabling subsequent kernel registry service memory writes includes setting a flag value in the kernel registry service.

6. The medium of claim 1, wherein disabling subsequent kernel registry service memory writes includes adding a flag value to the kernel registry service.

7. The medium of claim 1, wherein disabling subsequent kernel registry service memory writes includes setting a flag value in the kernel registry service.

8. A computer readable medium having a program to cause a device to perform a method, comprising:
editing a kernel configuration; and
holding the edited kernel configuration as a pending kernel configuration in memory with a current kernel configuration.

9. The medium of claim 8, wherein holding the edited kernel configuration includes saving the pending kernel configuration in a particular subdirectory that also includes the current kernel configuration.

10. The medium of claim 8, wherein holding the edited kernel configuration includes using a file name that is the same as the filename of the current kernel configuration.

11. The medium of claim 8, wherein holding the edited kernel configuration includes setting a flag in the kernel registry services to differentiate the pending kernel configuration from the current kernel configuration.

12. The medium of claim 8, further including setting a flag associated with a kernel registry service call to indicate that the kernel registry service call is to be applied to the pending kernel configuration.

13. The medium of claim 8, further including setting a flag associated with a kernel registry service call to indicate that the kernel registry service call is to be applied to the current kernel configuration.

14. The medium of claim 8, further including setting a flag associated with a kernel registry service call to indicate that the kernel registry service call is to be applied to the pending kernel configuration and a different flag to indicate that the kernel registry service call is to be applied to the current kernel configuration.

15. The medium of claim 8, wherein performing kernel configuration operations includes updating titles and modification times for saved and copied kernel configurations.

16. A kernel configuration tool, comprising:
a processor;
a memory coupled to the processor; and
program instructions provided to the memory and executable by the processor to:
force a write operation of kernel configuration information in a kernel registry service memory to a disk; and
disable subsequent kernel registry service memory writes to the disk while performing kernel configuration operations on the disk.

17. The tool of claim 16, wherein the kernel configuration operations include executing program instructions to update titles and modification times for saved and copied kernel configurations.

18. The tool of claim 16, wherein the program instructions execute to force the write operation of all kernel configuration information in the kernel registry service memory to one or more kernel registry files on the disk.

19. The tool of claim 16, wherein the program instructions can execute to automatically link pointers identifying the new kernel configuration to be used at the next boot.

20. The tool of claim 16, wherein the program instructions execute to force the write operation once a kernel configuration operation is initiated.

21. The tool of claim 20, wherein the kernel configuration operations include read, write, copy, and move.

22. The tool of claim 16, wherein the program instructions execute to force the write operation before a kernel configuration operation is initiated.

23. The tool of claim 16, wherein the program instructions to force a write operation of kernel configuration information are a synchronous operation.

24. The tool of claim 23, wherein program instructions execute to provide a confirmation that the forced write has been completed and wherein the subsequent kernel registry service memory writes are not disabled until the confirmation is provided.

25. A kernel configuration tool, comprising:
a processor;
a memory coupled to the processor; and
program instructions provided to the memory and executable by the processor to:
editing a kernel configuration; and
holding the edited kernel configuration as a pending kernel configuration in memory with a current kernel configuration.

26. The tool of claim 25, wherein a kernel registry service is used to store kernel configuration parameters for current and pending configurations.

27. The tool of claim 25, wherein holding the edited kernel configuration included storing pending kernel parameters that are to be held for next boot in a kernel memory copy of a kernel registry service.

28. The tool of claim 25, wherein the current and pending kernel configurations are saved in a particular node and are stored with the same name.

29. The tool of claim 25, wherein the saved current and pending kernel configurations each include a number of parameters and wherein each of the parameters includes a flag indicating it is for use with either the pending kernel configuration or the current configuration.

30. The tool of claim 25 wherein the tool and include program instructions to execute kernel registry service calls and wherein each of the calls can include a flag designating that pending or non-pending parameter values are to be used.

31. A kernel configuration system, comprising:
a kernel configuration tool;
a system file accessible by the kernel configuration tool; and
means for changing the state of kernel registry service memory writes between an enabled and a disabled state.

32. The system of claim 31, wherein the means for changing the state of kernel registry service memory writes includes providing a flag to be read by a kernel daemon which indicates the state of the kernel registry service memory writes.

33. The system of claim 31, wherein the means includes a set of program instructions executable on the system.

34. The system of claim 31, wherein the means for changing includes means for changing the state of the kernel registry service memory writes due to at least one of:
a system update;
a new install;
a kernel configuration change
a pre-boot change; and
a post-boot change.

35. A kernel configuration system, comprising:
a kernel configuration tool;
a system file accessible by the kernel configuration tool; and
means for holding an edited kernel configuration as a pending kernel configuration in memory with a current kernel configuration.

36. The system of claim 35, wherein the means for holding an edited kernel configuration includes providing a flag to identify to a daemon if a pending or current parameter is to be saved to disk.

37. The system of claim 36, wherein the flag is used to indicate that all next boot parameters are to be saved to disk.
